(19) United States
(12) Patent Application Publication
(10) Pub. No.: US 2016/0273607 A1
(43) Pub. Date: Sep. 22, 2016

(54) INTAKE VALVE FOR AIR SPRING SUSPENSION OF TRUCK CABINS

(71) Applicant: WONDER SPA, Cremona (IT)

(72) Inventors: Stefano CAZZANTI, Cremona (IT); Andrea CAPELLI, Cremona (IT); Maurizio COTTARELLI, Cremona (IT)

(21) Appl. No.: 14/898,941

(22) PCT Filed: May 20, 2014
(86) PCT No.: PCT/IT2014/000137

§ 371 Date: Dec. 16, 2015

(30) Foreign Application Priority Data
May 24, 2013 (IT) CR2013A000016

(51) Int. Cl. F16F 9/34

(52) U.S. Cl. CPC F16F 9/34; B62D 33/0608

(57) ABSTRACT

In an intake valve for air spring suspensions of truck cabins, the suspension is adapted to connect first and second mechanical elements with possibility of mutual movement and includes a variable volume chamber containing air; elastic element arranged between the mechanical elements; an intake valve for inflow of air into the chamber; an exhaust valve for outflow of air from the chamber. The intake valve includes: a valve body provided with an axial duct including an air inlet and outlet ports; an operating mechanism of the valve, including a piston and a spring. The piston includes a rod and a head and is arranged inside the valve body so vertical movement of its rod, in cooperation with the outlet port of the axial duct, defines a cross section area for air flow inside the chamber.

The present invention is aimed at the mechanical/automotive field and in detail relates to an intake valve for air spring suspensions of truck cabins, particularly suitable for use on light or heavy trucks, tractors of semi-trailers, articulated trucks, TIR trucks, lorries, tractors, camper vans, etc.

The air spring suspension of a truck cabin is an assembly of elastic components through which the chassis of the vehicle is connected to the cabin and is capable of absorbing and damping impacts caused by imperfections of the ground and consequently of guaranteeing the stability and comfort of the occupants.

In fact, if the entire mass of the vehicle were rigidly connected to the cabin, all the movements of the wheels and of the chassis would be transmitted directly to the driver's cabin, causing dangerous jolting for the driver, with consequent discomforts and, in the worst cases, loss of control of the vehicle.

Suspensions that are used in particular for truck cabins are those of the air type that exploit the different compressibility of a gas and of an elastic element.

These suspensions generally consist of a helical spring enclosed in a sealed flexible membrane defining a variable volume chamber, into which compressed air delivered from a circuit supplied by an external compressor is introduced by means of an intake valve or released by means of an exhaust valve.

Intake valves of the known type comprise a metal valve body provided with an axial duct adapted to connect the inside of the suspension chamber with the compressed air circuit.

Said axial duct is provided with an inlet port and an outlet port for the air and the actual operating mechanism of the valve slides inside said duct.

Cooperation between this operating mechanism and the inlet and outlet ports of the axial duct defines the cross section area for air flowing into the suspension chamber.

The movement of the operating mechanism opens or doses the ports of said axial duct, enabling or preventing air flow.

The operating mechanism substantially comprises a piston consisting of a head and of a rod, both cylindrical, a shutter, two helical springs and two sealing gaskets.

In the configuration with the valve closed, the piston is arranged at the end of the valve body inside the suspension chamber, with the rod completely outside the valve body and the head abutting on a first O-ring gasket positioned at the outlet port of the axial duct, thrust by a first spring.

The shutter, positioned in proximity of the opposite end of the valve body, is pressed against a second O-ring gasket by a second spring and air can enter the valve body only through a small axial orifice of the same shutter.

As a result of the start of compression of the elastic means of the suspension, the rod of the piston is pressed and the head abandons the closed position, moving vertically, sliding inside the axial duct and compressing said first spring associated therewith: the intake valve opens and the air, through the cross section area defined by the lobe-shaped outlet port in cooperation with the cylindrical rod of the piston, reaches the suspension chamber.

As the spring of the chamber is compressed, by higher loads, the piston continues its travel inside the axial duct plunging into and penetrating it until reaching the shutter that normally acts as a constriction for the cross section area for air flow.

By pressing vertically on this shutter, the piston moves it axially to the duct, releasing the seal on the second O-ring gasket and widening the cross section area for air flow into the valve body.

The relaxation of the two springs returns the valve to the dosed condition, with the shutter in the position constricting the cross section area for inflowing air and the piston abutting at the end of the valve body on the first O-ring gasket.

These intake valves have some limits and disadvantages, above all due to their geometry and to the complexity of their assembly.

Once the valve is open, to ensure different air flow modes, according to the extent of the shock absorbing effect desired for the vehicle cabin, the sliding movement of the piston inside the axial duct of the valve is not sufficient, but it is also necessary to act on further components, such as the shutter, and the related spring, which act to constrict the cross section area for air flow inside the axial duct.

Even more disadvantageously, the shutter only allows opening or closing of the constriction inside the axial duct, but not a gradual modulation of the cross section area for air flow.

A further disadvantage relates to the difficulty of maintaining all the components of the operating mechanism well aligned and in perfect line with the valve body, with the risk of deformation and malfunction of the valve.

Such a complex valve is also disadvantageously very costly and difficult to assemble.

The object of the invention is to overcome these limits, producing an intake valve that can be used in air spring suspensions with a smaller number of components and therefore easier to assemble and that is consequently less costly and more reliable.

Another object of the invention is to improve the operation of the same valve, also increasing the precision of the coupling and sliding system of its components.

These objects are achieved with an intake valve for air spring suspension of truck cabins, wherein said suspension is adapted to connect a first and a second mechanical element with possibility of mutual movement and comprises:

a variable volume chamber containing air;

elastic means arranged between said first and second mechanical element;

an intake valve for inflow of air into said chamber;

an exhaust valve for outflow of air from said chamber;

wherein said intake valve comprises:

a valve body provided with an axial duct comprising an inlet port for inflow of air into said valve and an outlet port for outflow of said air toward said chamber of said suspension;

an operating mechanism of said valve, comprising a piston and a spring, wherein said piston comprises a rod and a head and is arranged inside said valve body so that vertical movement of its rod, in cooperation with the outlet port of said axial duct, defines a cross section area for air flow inside said chamber,

characterized in that said rod is geometrically shaped to increase said cross section area for air flow as penetration of said rod in said duct increases.

According to a first embodiment of the invention, the variation of said cross section area for air flow is of gradual type or of sudden “stepped” type.

According to a first embodiment of the invention, said rod comprises a single longitudinal groove having a differentiated transverse cross section, smaller in proximity of the head and larger in proximity of the end of the rod opposite said head.

According to another possible embodiment of the invention, said rod comprises a first and a second longitudinal groove, both having a constant cross section but different length.

In particular, said first groove involves the whole length of the rod, while said second groove, of smaller length, extends only toward the end of the rod opposite its head.

Advantageously, said grooves have a triangular section.

Alternatively, said grooves have a section with a circular sector. According to a further embodiment of the invention, said head of said piston comprises a plurality of contact surfaces with the inner surface of said axial duct adapted to guide sliding of said piston.

In a preferred embodiment of the invention, said valve comprises a bushing, adapted to define the outlet port of said axial duct and to cooperate with the rod of said piston to define said cross section area for air flow.

The advantages of the intake valve according to the invention are evident:
the number of components has been reduced with respect to conventional valves, in fact the operating mechanism only comprises a spring, a piston and a gasket, but, as a result of the geometric shape of the piston rod, at the same time ensures correct operation of the valve with the possibility of varying the cross section area for air flow from the valve toward the inside of the suspension;
by reducing the number of components the whole system for assembly of the valve has been simplified;
production times and costs have been reduced;
with the simplifications made it is possible to replace some metal components with plastic parts, lightening the valve and further reducing costs.

In particular, simply by changing the geometry of the piston rod and modifying the cross section of its grooves, it is also possible to gradually vary the cross section area for air flow, modulating it according to need and to the load conditions, without causing sudden loads on the suspension and on the whole of its internal mechanism.

The dimensional variations of the piston, in particular the widening of the cross section of its head until producing contact surfaces with the inner surface of the axial duct, advantageously improves vertical sliding of the piston, which is maintained perfectly in line with the duct, improving the general functionality of the valve and eliminating the risk of deformations of the components.

Even more advantageously, the presence of the bushing at the end of the valve body ensures a further centering point for the rod of the piston during Its vertical movement.

These and other advantages will become more apparent from the following description of preferred embodiments of the invention, provided by way of non-limiting example, and with the aid of the figures, wherein:

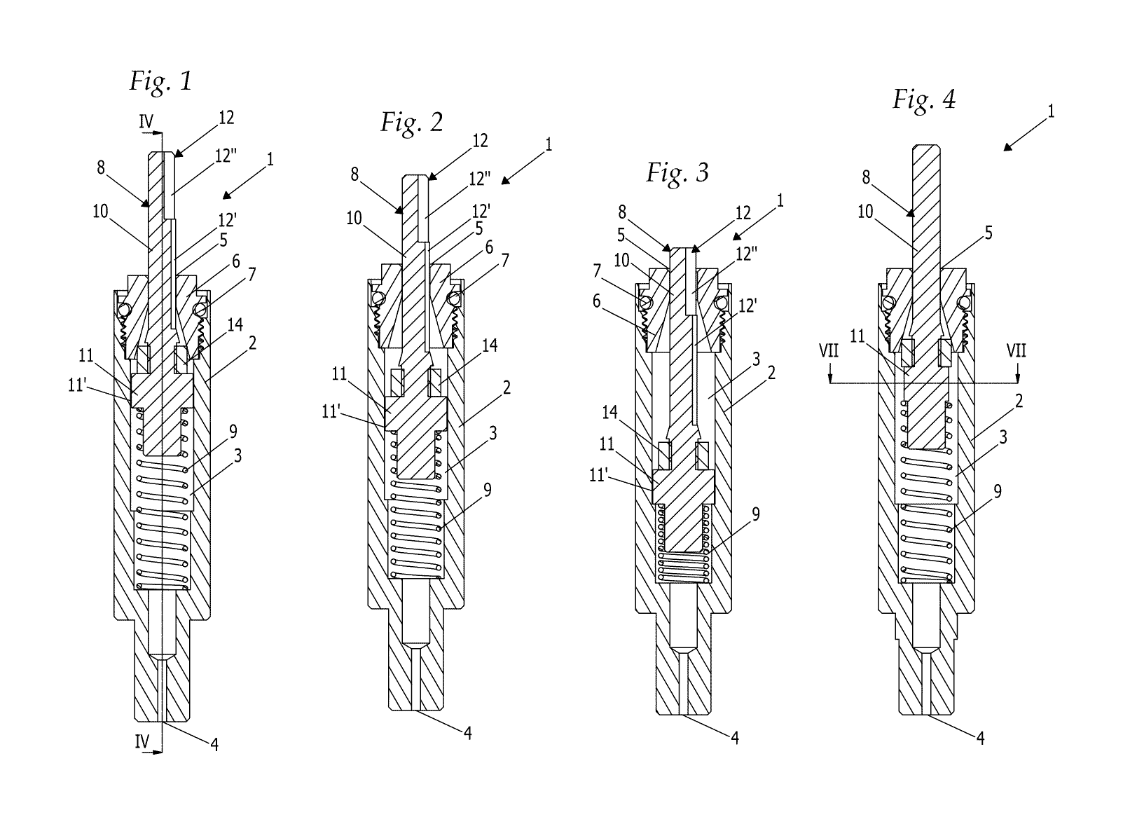

FIGS. 1-3 represent, in a longitudinal section, an intake valve for air suspensions according to the invention, in three different stages of opening;

FIG. 4 represents, in a longitudinal section along a plane perpendicular to the plane of the section of FIG. 1, the intake valve according to the invention;

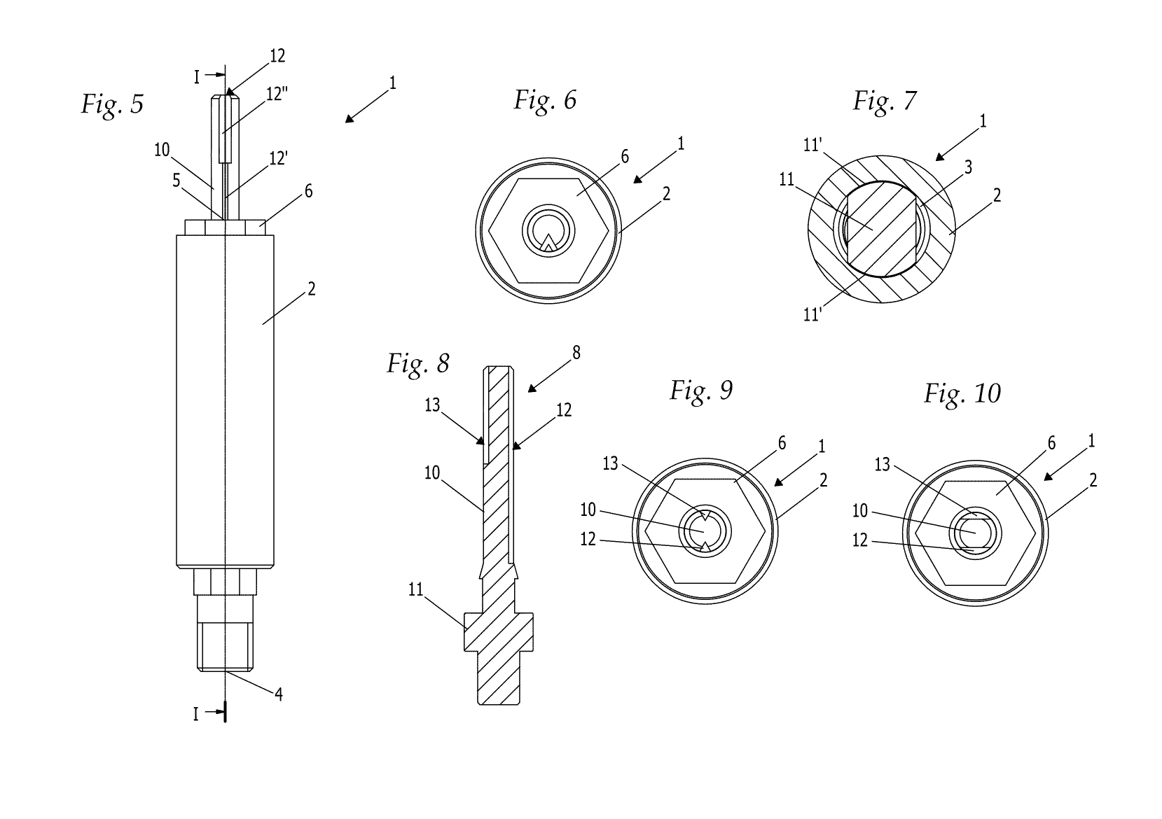

FIGS. 5 and 6 represent, respectively in a side view and in a top plan view, the intake valve in the configuration of FIG. 1;

FIG. 7 represents a cross section of the valve along the plane highlighted in FIG. 4;

FIG. 8 represents, in a longitudinal section, a component of the valve according to a possible variant of the invention;

FIGS. 9 and 10 represent, in a top plan view, an intake valve provided with the component of FIG. 8 according to two possible embodiments of the invention.

With reference to the figures, there is shown an intake valve 1 that can be used in an air spring suspension applicable to truck cabins, particularly those of heavy vehicles.

In general, this type of air spring suspension is adapted to connect a first and a second mechanical element with the possibility of mutual movement, such as the chassis of the vehicle and its cabin.

Said suspension substantially comprises:

a variable volume chamber containing air, delimited by flexible walls, for example a rubber membrane;

elastic means arranged between said first and second mechanical element, for example a helical spring;

an intake valve 1 to control inflow of air into said chamber, connected to a compressed air circuit supplied by an external compressor;

an exhaust valve to control outflow of air from said chamber.

As illustrated in the figures, said suction valve 1 comprises a rigid valve body 2, for example made of a metallic material, provided with an axial duct 3 that passes through it longitudinally, having a inlet port 4 with a circular section for inflow of compressed air into said valve 1 and an outlet port 5 with a circular section for outflow of said air toward the inside of the chamber of the same suspension.

Inside said axial duct 3 there slides an actual operating mechanism of the valve 1.

Said operating mechanism is composed of a piston 8 and of a spring 9 associated therewith: the movement of said piston 8 causes closing and opening of said valve 1, but also allows modulation of the cross section area for the air flow that, through said valve, reaches the suspension chamber.

As is particularly evident from the longitudinal sections of FIGS. 1-4, said piston 8 is composed of a rod 10 and of a head 11.

Said piston 8 cooperates with the inner surface of said axial duct 3, in particular with its outlet port 5, to define cross section areas for air flow inside said chamber, differentiated according to the length of the portion of rod 10 that penetrates the axial duct 3 of the valve 1.

In particular, said rod 10 is geometrically shaped to increase said cross section area for air flow as penetration of said rod 10 into said duct 3 increases.

According to a possible embodiment of the invention, shown in FIGS. 1-6, said rod 10 is provided with a longitudinal groove 12 with a length generally equal to the length of said rod or at least equal to its stroke.

The free space comprised between the inner surface of the outlet port 5 at the end of the axial duct 3 and said longitudinal groove 12 forms the cross section area for air flow from the valve 1 to the suspension chamber.

Said groove 12 is obtained by means of a channel with triangular section, as clearly shown in FIG. 6.

Along the extension of said groove 12, the channel varies in dimension: in particular, the section of the first portion 12′ of the channel provided on the portion of rod 10 next to the head 11 of the piston 8 has an area smaller than the area of the section of the second portion 12″ of the channel provided on the portion of rod 10 opposite the head 11 of the piston 8.

Penetration of the rod 10 into the duct 3 for a limited portion of its stroke, for example less than 14 mm, provides a relatively narrow cross section area for air flow, while further penetration thereof into the duct 3, for example for a portion of around 14-15 mm, increase said cross section area.

In a dimensional example of an intake valve 1 according to the invention, the cross section area defined by the first portion of channel 12′ is equal to a port having a diameter of 0.8 mm, such as the diameter of the inlet port 4, while the cross section area defined by the second portion of channel 12″ can reach a dimension equal to a port having a diameter of 1.3 mm.

The dimensional variation of the groove 12 between its two portions 12′, 12″ is of sudden, i.e. of the “stepped′ type, but in alternative embodiments, this variation can be of gradual type and the two portions of the channel 12′, 12” can be joined.

With particular reference to FIGS. 8-10, the rod 10 of said piston 8 instead comprises two longitudinal grooves 12, 13, diametrically opposite each other and having different length but same cross section: a first groove 12 has a length equal to the length of the whole rod 10, while a second groove 13 has a smaller length and involves the end portion of rod 10 opposite the head 11 of the piston 8.

Also in this case, penetration of the rod 10 into the duct 3 for a limited portion provides a relatively narrow cross section area for air flow consisting only of the space comprised between the first groove 12 and the inner surface of the outlet port 5 of the axial duct 3, while further penetration of the rod 10 increases this cross section defined by the space comprised between both grooves 12, 13 and the inner surface of the port 5.

In possible embodiments of the valve 1, the rod 10 can also comprise a plurality of grooves and, by suitably designing their section, their length and their distribution along the rod, it is possible to modify the cross section area for air flow as penetration of the rod 10 into the duct varies.

The embodiments of the valve 1 in which the rod 10 only comprises a groove 12 with cross section with variable dimensions are however better with respect to the embodiments with two or more grooves, as the sliding surface of the rod 10 in the port 5 is larger and therefore ensures more precise centering of the whole piston 8 in the axial duct 3 of the valve 1.

In the embodiment of FIG. 9, said grooves 12, 13 are produced with slots with triangular section, while in the embodiment of FIG. 10 said grooves have a section with circular sector and are produced, for example, by means of flattenings.

As it is apparent from the sections of FIGS. 4 and 7, the head 11 of said piston 8 comprises a plurality of contact surfaces 11′ with the inner surface of said axial duct 3, producing a sort of centering collar adapted to promote sliding of said piston 8 inside said duct.

Moreover, as shown in all the figures, said valve 1 comprises a bushing 6, comprising the outlet port 5 of the axial duct 3 of said valve body 2, adapted to cooperate with the rod 10 of said piston 8 for its centering.

In said embodiment, the bushing 6 defines the outlet port 5 for air outflow from the valve 1 and cooperates with said rod 10 to define the cross section areas for air flow.

Said bushing 6 can advantageously be made of different materials with respect to the valve body 2 and to the piston 8, to facilitate sliding of the latter. For example, said bushing 6, said valve body 2 and said piston 8 can be made of plastic, or steel, or brass, or nylon reinforced with glass, according to production requirements and conditions.

Moreover, said bushing 6 could be screwed into the valve body 2 with interposition of an O-ring gasket 7, or forced into the specific seat and then deformed to prevent its removal.

Between the head 11 of the piston 8 and said bushing 6, inside the axial duct 3, there is interposed a further air-tight gasket 14, functional in the condition with the valve 1 closed shown in the sections of FIGS. 1 and 4.

To facilitate the seal with said gasket 14, the bushing 6 can have a conical shaped duct leading toward the outlet port 5.

Operation of the valve 1 according to the invention is described below.

FIG. 1 shows the valve 1 closed, a condition in which the suspension chamber maintains a constant volume and the vehicle cabin is connected to the chassis with a certain degree of rigidity.

A sudden mutual movement between vehicle cabin and chassis, for example due to an uneven road surface over which the same vehicle is traveling, requires opening of the valve 1 and air to be necessarily introduced into the chamber to counter the weight of the same cabin, which would otherwise affect the chassis.

The opening of valve 1 takes place through vertical sliding of the piston 8 into the axial duct 3 of the valve body 2.

Sliding of the piston 8 into the duct 3 for a portion less than the length of the first portion 12′ of the groove obtained on its rod 10, defines a cross section area for air flow of limited dimension, and therefore introduces a small flow of air into the suspension chamber.

This condition, shown in the section of FIG. 2, occurs when only minor absorption of jolting of the cab is required.

In conditions of increased load, the piston 8 must instead penetrate the axial duct 3 of the valve 1 further: in this way, due to the shape of the second portion 12″ of groove obtained thereon, the rod 10 defines a cross section area for air flow of much larger dimension, as shown in FIG. 3, thereby allowing a larger amount of air to flow into the suspension chamber.

The natural relaxation of the spring 9, which during penetration of the piston 8 into the axial duct 3 was compressed, returns the head 11 of the piston 8 in abutment on the outlet port 5 for outflow of air from the valve 1, thereby closing the same valve.

1. An intake valve (1) for air spring suspension of truck cabins, wherein said suspension is adapted to connect a first and a second mechanical element with possibility of mutual movement and comprises:
a variable volume chamber containing air;
elastic means arranged between said first and second mechanical element;
an intake valve (1) for inflow of air into said chamber;
an exhaust valve for outflow of air from said chamber;
wherein said intake valve (1) comprises:
a valve body (2) provided with an axial duct (3) comprising an inlet port (4) for inflow of air into said valve (1) and an outlet port (5) for outflow of said air toward said chamber of said suspension;
an operating mechanism of said valve (1), comprising a piston (8) and a spring (9),
wherein said piston (8) comprises a rod (10) and a head (11) and is arranged inside said valve body (2) so that the vertical movement of the rod (10), in cooperation with the outlet port (4) of said axial duct (3), defines a cross section area for air flow inside said chamber,
wherein said rod (10) is geometrically shaped to increase said cross sectional area for air flow as penetration of said rod (10) in said duct (3) increases.

2. The intake valve (1) according to claim 1, wherein the variation of said cross sectional area for air flow is of gradual type or of sudden “stepped” type.

3. The intake valve (1) according to claim 1, wherein said rod (10) comprises a single longitudinal groove (12) having a differentiated cross section, smaller in proximity of the head (11) and larger in proximity of the end of the rod (10) opposite said head.

4. The intake valve (1) according to claim 1, wherein said rod (10) comprises a first (12) and a second (13) longitudinal groove, both having a constant transverse cross section but different length.

5. The intake valve (1) according to claim 4, wherein said first groove (12) involves the whole length of the rod (10), while said second groove (13), of smaller length, extends only toward the end of said rod (10) opposite the head (11).

6. The intake valve (1) according to claim 3, wherein said grooves (12, 13) have a triangular section.

7. The intake valve (1) according to claim 3, wherein said grooves (12, 13) have a cross section with a circular sector.

8. The intake valve (1) according to claim 1, wherein said head (11) of said piston (8) comprises a plurality of contact surfaces (11′) with the inner surface of said axial duct (3), adapted to guide sliding of said piston.

9. The intake valve (1) according to claim 1, further comprising a bushing (6), adapted to define the outlet port (5) of said axial duct (3) and to cooperate with the rod (10) of said piston (8) to define said cross sectional area for air flow.

10. The intake valve (1) according to claim 4, wherein said grooves (12, 13) have a triangular section.

11. The intake valve (1) according to claim 4, wherein said grooves (12, 13) have a cross section with a circular sector.
